(19) United States
(12) Patent Application Publication
(10) Pub. No.: US 2009/0119175 A1
(43) Pub. Date: May 7, 2009

(54) TAPE SEALANT

(76) Inventor: John Richardson, Chandler, AZ (US)

Correspondence Address: KEITH L. JENKINS, 2222 NORTH MCQUEEN ROAD #2069, CHANDLER, AZ, 85225, US

(21) Appl. No.: 12/267,513

(22) Filed: Nov. 7, 2008

Related U.S. Application Data
(60) Provisional application No. 60/985,995, filed on Nov. 7, 2007.

(51) Int. Cl. G06Q 30/00; G06Q 90/00

(52) U.S. Cl. 705/14; 705/500

(57) ABSTRACT

A formulated transparent acrylic emulsion is packaged and marketed as tape sealant that gives superior sharp paint boundaries when used in conjunction with masking tape, including modem types that of masking tapes that claim to prevent seepage. Methods of formulating and using the tape sealant, as well as marketing approaches, are included.

### RELATED APPLICATIONS

This application claims the benefit of provisional patent application No. 60/985995 filed Nov. 7, 2007 by the same inventor for TAPE SEALANT.

### STATEMENT REGARDING FEDERALLY SPONSORED RESEARCH

No federal research funds were used in the development of this invention.

### FIELD OF THE INVENTION

The present invention generally relates to making and selling a composition of matter for use by painters. The present invention more particularly relates to methods of making and selling an acrylic emulsion, with additives, for use in masking operations.

### BACKGROUND OF THE INVENTION

Painters use masking tape to define borders for painted areas of surfaces such as walls, doors, window frames, and the like. Masking tape is first applied to the surface to be painted, with the tape positioned such that one edge of the masking tape defines a boundary edge of the area to be painted. Paint is then applied to the surface to be painted and to at least part of the masking tape adjacent the edge of the masking tape. The masking tape is then removed, hopefully leaving a sharp boundary between the painted and unpainted portions of the surface. Current masking tapes do not always define a sharp edge, however, because the paint may, by virtue of its particular viscosity, bleed under the edge of the tape or be drawn under the tape by capillary action. U.S. Pat. No. 6,828,008 to Gruber issued Dec. 12, 2004 for ADHESIVE TAPE FOR MASKING (hereinafter “Gruber”) discloses a masking tape with an absorbent edge coating that is marketed as Frog Tape. Gruber works well for smooth surfaces, but many walls are textured, and Gruber is not effective on such walls. The result is a paint boundary that is not sharp and may be unsightly. Also, according to the advertisements for Frog Tape at http://www.frogtape.com/, Gruber may be limited to use with latex paint. If a technical solution to these problems can be found, it still remains to bring it to market in a way that will cause painters to recognize its advantages and buy it.

### SUMMARY OF THE INVENTION

In order to solve the aforementioned problems, meet the aforementioned needs, and for other advantages, as will become apparent, the inventor provides a tape sealant business method that includes formulating an acrylic composition for use as a tape sealant, packaging the tape sealant for the painter's market, advertising the tape sealant in the painter's market, and selling the tape sealant in the painter's market.

### BRIEF DESCRIPTION OF THE DRAWINGS

FIG. 1A is a side cross-sectional elevation view, with exaggerated vertical scale, of an exemplary embodiment of a step of the tape sealant method of use, according to a preferred embodiment of the present invention;

FIG. 1B is a side cross-sectional elevation view, with exaggerated vertical scale, of an exemplary embodiment of the step of the tape sealant method of use shown in FIG. 1A at another portion of the tape, according to a preferred embodiment of the present invention;

FIG. 1C is a side cross-sectional elevation view, with exaggerated vertical scale, of an exemplary embodiment of a subsequent step to the step in FIG. 1B of the tape sealant method of use, according to a preferred embodiment of the present invention;

FIG. 1D is a side cross-sectional elevation view, with exaggerated vertical scale, of an exemplary embodiment of another subsequent step to the step in FIG. 1C of the tape sealant method of use, according to a preferred embodiment of the present invention;

FIG. 1E is a side cross-sectional elevation view, with exaggerated vertical scale, of an exemplary embodiment of a subsequent step to the step in FIG. 1A of the tape sealant method of use, according to a preferred embodiment of the present invention;

FIG. 2 is a process diagram illustrating the steps of formulating an exemplary embodiment of the tape sealant, according to a preferred embodiment of the present invention;

FIG. 3 is a process diagram illustrating the steps of an exemplary embodiment of the tape sealant business method, according to a preferred embodiment of the present invention;

FIG. 4 is a process diagram illustrating the steps of an exemplary embodiment of the tape sealant method of use, according to a preferred embodiment of the present invention;

FIG. 5A is a side cross-sectional elevation view, with exaggerated vertical scale, of a prior art application of masking tape;

FIG. 5B is a side cross-sectional elevation view, with exaggerated horizontal and vertical scale, of the result of a further prior art step in the removal of masking tape of FIG. 5A;

FIG. 5C is a top plan view, with exaggerated horizontal scale, of the result of the prior art step of the removal of masking tape of FIG. 5B; and

FIG. 5D is a top plan view, with exaggerated horizontal scale, of an exemplary embodiment of a the step shown in FIG. 1D and FIG. 1E of the tape sealant method of use, according to a preferred embodiment of the present invention.

### DETAILED DESCRIPTION OF THE DRAWINGS

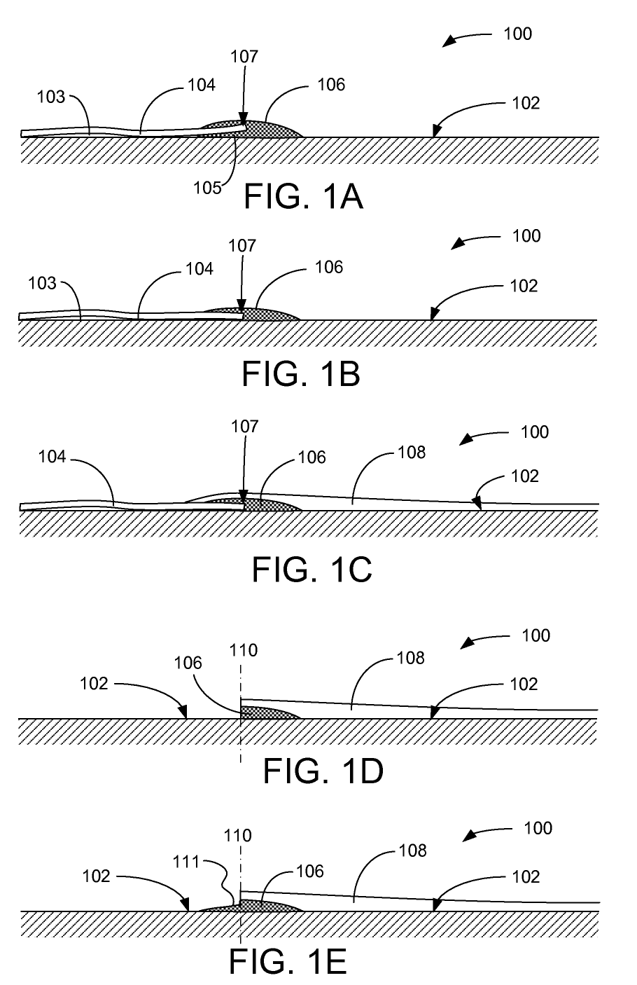

FIG. 1A is a side cross-sectional elevation view, with exaggerated vertical scale, of an exemplary embodiment of a step of the tape sealant 106 method of use, according to a preferred embodiment of the present invention. A surface 102 to be painted has masking tape 104 applied to it. Ideally, the masking tape 104 would lie flat against surface 102. However, at the microscopic level, there all always voids 103 and 105 between the masking tape 104 and the surface 102, due to irregularities in the surface 102 and imperfect application of the masking tape 104. Some of those voids 105 may occur near the edge of the masking tape 104, allowing paint to bleed under the masking tape 104. Tape sealant 106 may bleed under the masking tape 104 and into void 105, as shown, but, because it is transparent, the tape sealant does not detract from the ultimate appearance of the paint boundary 110 (See FIG. 1D and FIG. 1E). Tape sealant 106 is applied, preferably by brush, along the edge of the masking tape 104, covering part of masking tape 104 and part of surface 102, as shown. In an alternate embodiment in which the viscosity of the tape sealant 106 is very high, tape sealant 106 will not flow into void 105, but will create a barrier to paint 108 (See FIG. 1C) flowing into void 105. Whether the tape sealant 106 bleeds, or seeps, under the masking tape 104 or not, the tape sealant 106 will prevent the paint 106 from doing bleeding under the masking tape 104. The use of transparent tape sealant ensures the appearance of a sharp paint boundary 110 whether the tape sealant 106 bleeds under the masking tape or not.

FIG. 1B is a side cross-sectional elevation view, with exaggerated vertical scale, of an exemplary embodiment of a step of the tape sealant 106 method of use shown in FIG. 1A at another portion of the tape, according to a preferred embodiment of the present invention. FIG. 1B illustrates the tape sealant 106 applied to the masking tape 104, shown without a void 105, and to tape edge 107, and to the surface 102. The tape sealant 106 creates a barrier to any paint 108 (see FIG. 1C) or other coating that may bleed under masking tape 104 or which may wick into the edge 107 of masking tape 104.

FIG. 1C is a side cross-sectional elevation view, with exaggerated vertical scale, of an exemplary embodiment of a subsequent step to the step in FIG. 1B of the tape sealant method of use, according to a preferred embodiment of the present invention. In FIG. 1C, paint 108 has been applied over a portion of masking tape 104, tape sealant 106, and surface 102. Preferably, tape sealant 106 provides good adhesion for paint 108.

FIG. 1D is a side cross-sectional elevation view, with exaggerated vertical scale, of an exemplary embodiment of another subsequent step to the step in FIG. 1C of the tape sealant 106 method of use, according to a preferred embodiment of the present invention. In FIG. 1D, masking tape 104 has been removed in the known way, leaving sharp paint boundary 110 between painted 108 portions of surface 102 and unpainted surface 102. The tape sealant 106 is preferably transparent, and so does not detract from the sharp appearance of the sharp paint boundary 110. The vertical scale of FIGS. 1A-1D is exaggerated: in practice, the thickness of the tape sealant 106 layer would be substantially less than the thickness of the paint 108 layer. Depending on the type of paint 108, the user may wish to remove the masking tape 104 before the paint 108 is completely dry: some plasticity in the paint 108 may avoid irregular cracking along sharp paint boundary 110.

FIG. 1E is a side cross-sectional elevation view, with exaggerated vertical and horizontal scale, of an exemplary embodiment of a subsequent step to the step in FIG. 1A of the tape sealant 106 method of use, according to a preferred embodiment of the present invention. Tape sealant has bled into void 105, and removal of the masking tape 104 has left a portion 111 of paint sealant 106 on the portion of surface 102 that was not to have been painted. Because tape sealant 106 is transparent, the appearance of a sharp paint boundary is maintained. Depending on the finish on unpainted surface 102, transparent tape sealant 106 with a glossy or, alternatively, flat luster may be desired.

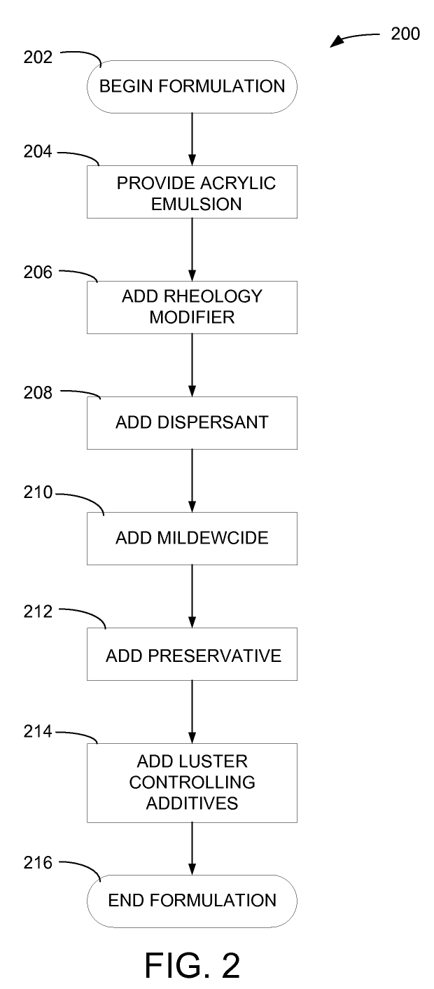

FIG. 2 is a process diagram illustrating the steps of formulating 200 an exemplary embodiment of the tape sealant 106, according to a preferred embodiment of the present invention. In step 202, the formulation process begins with providing facilities, equipment, and supplies for formulating 200 the tape sealant 106. Step 204 provides a formulated acrylic emulsion, such as those known in the art to be used as a base for acrylic paints. The formulated acrylic emulsion provided in step 204 is preferably transparent. Transparency need not be absolute, and is defined and used herein to mean at least 90% transparent, and preferably more than 98% transparent, when applied and dried. The formulated transparent acrylic emulsion may not be transparent before drying. In a preferred embodiment, the formulated transparent acrylic emulsion appears white in the container and on the brush, but dries transparent when applied. The formulated transparent acrylic emulsion, which may be further formulated, as described in more detail below, is marketed and used as tape sealant 106. Those of skill in the art, enlightened by this disclosure, will appreciate that, for some applications, the formulated transparent acrylic emulsion will suffice as a tape sealant 106 and that further formulations steps are unnecessary.

In step 206, a rheology modifier, or viscosity modifier, is added to the formulated transparent acrylic emulsion to create a higher viscosity. Preferably, the rheology modifier creates a tape sealant 106 that does not bleed under the tape 104 and does not move (wick) into the edge of the tape 104 by capillary action. In an alternate embodiment, the rheology modifier may create a lower viscosity tape sealant 106 which does bleed under the tape 104, but which remains transparent and so leaves a sharp paint boundary 110 between the painted and unpainted portions of the surface 102. Those of skill in the art, enlightened by this disclosure, will appreciate that, for some applications, the viscosity-modified formulated transparent acrylic emulsion will suffice as a tape sealant 106 and that further formulations steps are unnecessary.

In step 208, a dispersant may be added to the formulated transparent acrylic emulsion provided in step 204 or 206 to improve the properties of the tape sealant 106 for use with a paint brush. The dispersant is preferably selected to maintain the transparency of the tape sealant 106. In various alternate embodiments, the dispersant properties of the tape sealant 106 may be adapted for use with various types of applicators. For example, the dispersant properties of the tape sealant 106 may be adapted for use with a sponge applicator, roller, or sprayer. Those of skill in the art, enlightened by this disclosure, will appreciate that, for some applications, the viscosity-modified, dispersant-added formulated transparent acrylic emulsion will suffice as a tape sealant 106 and that further formulation steps are unnecessary. Those of skill in the art, enlightened by this disclosure, will also appreciate that, for some applications, a dispersant-added formulated transparent acrylic emulsion will not require a rheology modifier or other additive.

In step 210, a mildewcide is added to the formulated transparent acrylic emulsion provided in step 204, 206, or 208 to resist mildew growth in the formulated transparent acrylic emulsion in a container and in the tape sealant 106 as applied. The mildewcide is preferably selected to maintain the transparency of the tape sealant 106. Those of skill in the art, enlightened by this disclosure, will appreciate that, for some specialized applications, other biocides may be added. For example, fungicides, germicides, anti-viral agents, and even pesticides and herbicides may be added. Those of skill in the art, enlightened by this disclosure, will appreciate that, for some applications, the viscosity-modified, dispersant-added, mildew-resistant, formulated transparent acrylic emulsion will suffice as a tape sealant 106 and that further formulation steps are unnecessary. Those of skill in the art, enlightened by this disclosure, will also appreciate that, for some applications, a biocide-added formulated transparent acrylic emulsion will not require a rheology modifier, dispersant, or other additive.

In step 212, a preservative is added to the formulated transparent acrylic emulsion provided in steps 204, 206, 208, or 210 to prolong shelf life and useful life of the tape sealant 106. The preservative is preferably selected to maintain the transparency of the tape sealant 106. Those of skill in the art, enlightened by this disclosure, will appreciate that, for some applications, the viscosity-modified, dispersant-added, mildew-resistant, preservative-prolonged formulated transparent acrylic emulsion will suffice as a tape sealant 106 and that further steps are unnecessary. Those of skill in the art, enlightened by this disclosure, will also appreciate that, for some applications, a preservative-added formulated transparent acrylic emulsion will not require a rheology modifier, dispersant, biocide, or other additive.

In step 214, additives that control luster, from matte to glossy, are added to the formulated transparent acrylic emulsion provided in step 204, 206, 208, 210, or 212. The luster additives are preferably selected to maintain the transparency of the tape sealant 106. In one embodiment, luster additives may provide a glossy appearance, to match glossy surfaces 102. In another embodiment, luster additives may provide a matte appearance, to match matte surfaces 102. Various levels of luster, between gloss and matte, may be achieved by appropriate addition of luster-controlling additives. Those of skill in the art, enlightened by this disclosure, will appreciate that, for some applications, the rheology-modified, dispersant-added, mildew-resistant, preservative-prolonged, luster-modified formulated transparent acrylic emulsion will suffice as a tape sealant 106 and that further steps are unnecessary. Those of skill in the art, enlightened by this disclosure, will also appreciate that, for some applications, a luster-modified formulated transparent acrylic emulsion will not require a rheology modifier, dispersant, biocide, preservative or other additive.

Any, all, or none of the additives may be used for a particular embodiment of the formulated transparent acrylic emulsion packaged as tape sealant 106, and the list of rheology modifiers, dispersants, biocides, preservatives, and luster modifiers is exemplary rather than exhaustive.

In step 216, the formulation of the tape sealant 106 is completed with mixing, pouring, and storing of the tape sealant 106. An exemplary container for storing and marketing formulated transparent acrylic emulsion packaged as tape sealant 106 is a 16 oz. plastic jar with a screw cap and a label bearing the text TAPE-SEAL, along with instructions for use and additional advertising. A similar container in an 8 oz. size is also preferred. For wholesale sales, cartons of the 8 oz. or 16 oz. labeled containers may be used, as well as larger labeled containers, as are known in the art of containing paint. Bulk formulated transparent acrylic emulsion may be transported and stored in containers normally used for acrylic paint.

It should be understood that steps 204, 206, 208, 210, 212, and 214 may be performed in any order. Likewise, the order of performing steps 206 and 208 may be reversed. The inventor regards all such combinations of the illustrated steps 202, 204, 206, 208, 210, 212, 214, and 216 to be within the scope of the present invention.

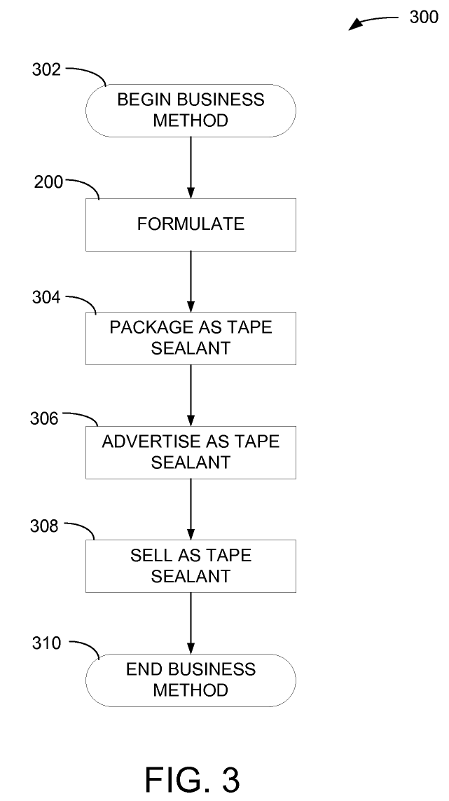

FIG. 3 is a process diagram illustrating the steps of an exemplary embodiment of the tape sealant 106 business method, or process, 300, according to a preferred embodiment of the present invention. The business method 300 begins in step 302 with the preparatory activities of arranging for and organizing the capital and labor needed to engage in the business. The next step is step 200, which covers the formulation of the tape sealant 106. Step 200 is covered in detail in the discussion of FIG. 2, above.

Marketing of the tape sealant 106 is covered by steps 304, 306 and 308. Marketing may include retail, wholesale, and bulk marketing of the formulated transparent acrylic emulsion as tape sealant 106. As used and defined herein, “marketing” includes distribution. Retail marketing includes retail internet marketing. For example, the present inventor's website, http://www.perfectpaintlines.com/, provides retail and wholesale marketing of formulated transparent acrylic emulsion as tape sealant 106. Retail marketing also includes retail store marketing, which includes temporary retail stores, such as trade show booths and promotional kiosks. Wholesale marketing may be done over the internet, by catalogue, trade shows and trade publications, or by other conventional means, such as mail order or purchase orders. Bulk marketing is also within the scope of the present invention, in which bulk quantities of formulated transparent acrylic emulsion may be marketed to various brand name companies for packaging under their own brands.

From the business perspective, the formulated transparent acrylic emulsion may be formulated by the business or may be purchased from a company that specializes in formulating acrylic compositions to buyer's specifications.

In step 304, the formulated transparent acrylic emulsion produced by step 200, or otherwise acquired, is packaged as tape sealant 106. This step includes selection of packages that will be convenient for painters to use, labeling, and bundling of instructions and illustrations for use. In a preferred embodiment, the tape sealant 106 is packaged in a kit with instructions for use, which may be printed on a retail package or may be printed on a separate document. In a particular embodiment, instructions may be downloadable from an internet website with an online receipt for an internet order or with a shipping confirmation. In another particular embodiment, the tape sealant 106 may be packaged in a kit with an applicator, such as a paintbrush, selected for use with tape sealant 106. In yet another embodiment, the tape sealant 106 may be bundled in a kit with an applicator and a tape tool, such as the one that forms the subject matter of design patent application Ser. No. 29/295,805 to the present inventor. In another embodiment, the tape sealant 106 may be packaged in a kit with masking tape. Given a kit with the tape sealant 106 and the instructions, any one of tape tool, masking tape, and applicator may also be included in the kit.

In step 306, the formulated transparent acrylic emulsion is advertised for sale as tape sealant 106. The advertising preferably presents the method of use of the tape sealant 106 and the advantages of obtaining a sharp paint boundary 110 between the painted and unpainted portions of surface 102. Advertising is preferably targeted towards professional painters, but may also include retail advertising. Advertising on the worldwide web using text, graphics, audio, and video at the inventor's website http://www.perfectpaintlines.com/, for example, is also included in step 306. The product is preferably advertised as TAPE-SEAL, but wholesale and bulk sales to other brands is within the scope of the present invention. Advertising in the form of trade show displays, trade publication advertisements, and retail advertising of said formulated transparent acrylic emulsion as a tape sealant are also within the scope of the present invention.

In step 308, the packaged formulated transparent acrylic emulsion is sold as tape sealant 106. While wholesale distribution and sale is preferred, bulk sales of the tape sealant 106 is also within the scope of this step. Retail selling is included in step 308 and is preferably through retail outlets that serve professional painters, but retail internet sales such as http://www.perfectpaintlines.com/tapr.html are also within the scope of step 308. Sales are also made at retail stores.

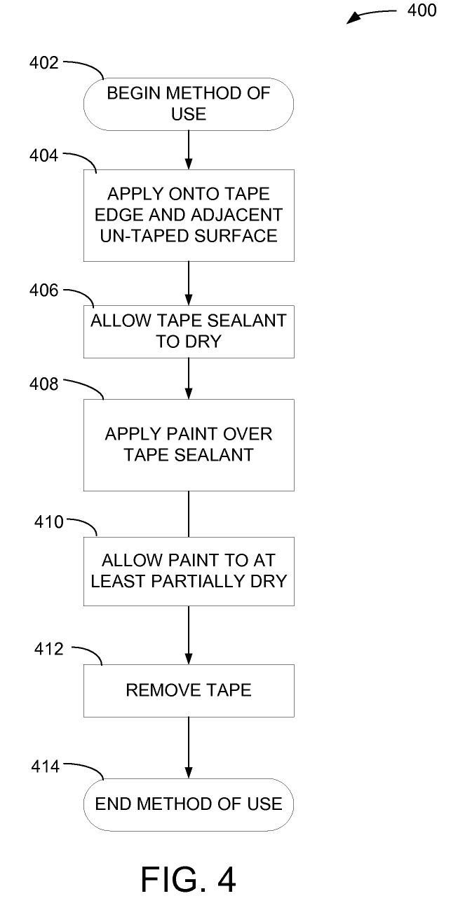

FIG. 4 is a process diagram illustrating the steps of an exemplary embodiment of the tape sealant 106 method of use 400, according to a preferred embodiment of the present invention. Step 402 begins the method of use 400 by arranging a painter, a supply of tape sealant 106, and a supply of masking tape 104 proximate a surface 102 to be masked and painted. The masking tape 104 is then applied to surface 102 in the conventional way and in a pattern depending on the requirements of the particular job.

In step 404, tape sealant 106 is applied along the edge 107 of masking tape 104, on adjacent portions of masking tape 104, and on adjacent portions of surface 102. The application may be by means of any of the applicators mentioned above. The application should preferably provide the thinnest layer of tape sealant 106 that is consistent with the needs of the particular job.

In step 406, time is provided for the tape sealant 106 to dry to a condition where it can receive a coat of paint 108 without the paint 108 and tape sealant 106 intermixing and without the tape sealant 106 dissolving pigment from paint 108 into the tape sealant 106. The exact drying time will depend on the viscosity of the tape sealant 106, local humidity, initial dryness of the surface 102, porosity of surface 102, and the nature of the paint 108 to be applied. The assessment of such factors are within the level of skill of a professional painter. Amateur painters may be instructed to allow the tape sealant 106 to dry to the touch, which may be tested on the portion of tape sealant 106 overlying the masking tape 104, so that fingerprints on incompletely dried tape sealant 106 may be removed with the masking tape 104.

In step 408, one or more coats of paint 108 are applied to surface 102, tape sealant 106, and, optionally, an adjacent portion of masking tape 104. Application may be by any means.

In step 410, the paint 108 is allowed to at least partially dry. While this may not seem too complicated, some art is required in judging the right amount of time. If the paint dries completely, cracking of the paint 108 along the sharp paint boundary 110 may occur, marring the appearance. If the paint 108 is too wet, it may flow after the masking tape 104 is removed, creating an uneven appearance. The tackiness of the paint may be tested on paint 108 overlying the masking tape 104 by making fingerprints in the paint 108. The fingerprints may later be removed with the masking tape 104. If the ridges of the fingerprint in the paint 108 flow together, the paint 108 has not dried enough. If the ridges of the fingerprint in the paint 108 maintain definition, the tape may be removed.

In step 412, the masking tape 104 is removed, leaving a sharp paint boundary 110 between the painted and unpainted portions of surface 102. The tape should be lifted along its length, with a minimum of side motion to produce the desired result. In step 414, the method ends with the usual clean up.

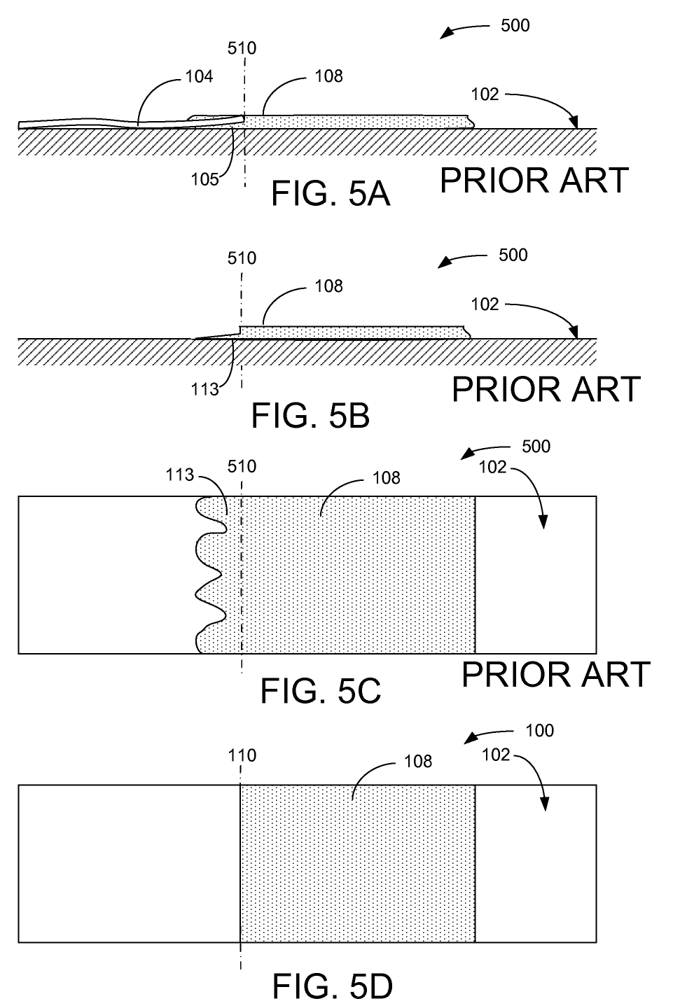

FIG. 5A is a side cross-sectional elevation view, with exaggerated vertical scale, of a prior art application 500 of masking tape 104. Paint 108 seeps across intended paint boundary 510 into void 105 under the masking tape 104 and sticks to surface 102 on the portion of surface 102 not intended to be painted.

FIG. 5B is a side cross-sectional elevation view, with exaggerated vertical and horizontal scale, of the result of a further prior art step in the removal of masking tape 104 of FIG. 5A. Portion 113 of paint 108 extends across the intended paint boundary 510 and gives an irregular appearance to the intended paint boundary 510.

FIG. 5C is a top plan view, with exaggerated horizontal scale, of the result of the prior art step of the removal of masking tape 104 of FIG. 5B. The irregularity of the edge of portion 113 of the paint 108 on the side of intended paint boundary 510 diminishes the quality of the paint job.

FIG. 5D is a top plan view, with exaggerated horizontal scale, of an exemplary embodiment of the step shown in FIG. 1D and FIG. 1E of the tape sealant 104 method 100 of use, according to a preferred embodiment of the present invention. Sharp paint boundary 110 is not encroached by any visible portion 113 of paint 108, providing an appearance regarded as a high quality paint job.

Although applicant has described applicant's preferred embodiment of this invention, it will be understood that the broadest scope of this invention includes modifications such as diverse packages, advertising approaches, and materials. Such scope is limited only by the below claims as read in connection with the above specification. Further, many other advantages of applicant's invention will be apparent to those skilled in the art from the above descriptions and the below claims.

I claim:

1. A process for marketing formulated transparent acrylic emulsion as a tape sealant, the process comprising the steps of:
a. acquiring a formulated transparent acrylic emulsion; and
b. marketing said formulated transparent acrylic emulsion as a tape sealant.

2. The process of claim 1, wherein said formulated transparent acrylic emulsion comprises a transparent acrylic emulsion.

3. The process of claim 1, wherein said formulated transparent acrylic emulsion comprises a rheology modifier.

4. The process of claim 1, wherein said formulated transparent acrylic emulsion comprises a biocide.

5. The process of claim 1, wherein said formulated transparent acrylic emulsion comprises a dispersant.

6. The process of claim 1, wherein said formulated transparent acrylic emulsion comprises a preservative.

7. The process of claim 1, wherein said formulated transparent acrylic emulsion comprises a luster-controlling agent.

8. The process of claim 1, wherein said marketing comprises the step of packaging said formulated transparent acrylic emulsion as a tape sealant.

9. The process of claim 8, wherein said packaging comprises producing a retail kit comprising:
a. formulated transparent acrylic emulsion in a container, wherein said container comprises a label identifying said formulated transparent acrylic emulsion as a tape sealant; and
b. instructions for using said formulated transparent acrylic emulsion as a tape sealant.

10. The process of claim 9, wherein said retail kit further comprises at least one of:
a. an applicator for applying said formulated transparent acrylic emulsion as a tape sealant;
b. a tape tool; and
c. masking tape.

11. The process of claim 1, wherein said marketing comprises at least one of:
a. retail internet marketing of said formulated transparent acrylic emulsion as a tape sealant;
b. retail store marketing of said formulated transparent acrylic emulsion as a tape sealant;
c. wholesale marketing of said formulated transparent acrylic emulsion as a tape sealant;
d. bulk marketing of said formulated transparent acrylic emulsion for use as a tape sealant;

12. The process of claim 1, wherein said marketing comprises the step of advertising said formulated transparent acrylic emulsion as a tape sealant.

13. The process of claim 12, wherein said advertising comprises at least one of:
a. internet advertising of said formulated transparent acrylic emulsion as a tape sealant;
b. trade show advertising of said formulated transparent acrylic emulsion as a tape sealant;
c. retail advertising of said formulated transparent acrylic emulsion as a tape sealant; and
d. trade publication advertising of said formulated transparent acrylic emulsion as a tape sealant.

14. The process of claim 1, wherein said marketing comprises the step of selling said formulated transparent acrylic emulsion as a tape sealant.

15. The process of claim 14, wherein said selling comprises at least one of:
a. selling formulated transparent acrylic emulsion packaged as a tape sealant to retail customers at least one of:
i. over the internet;
ii. at a trade show; and
iii. in a retail store;
b. selling formulated transparent acrylic emulsion packaged as a tape sealant to wholesale customers at least one of:
i. on an internet wholesale sales web page;
ii. using mail-order; and
iii. using purchase orders; and
c. selling formulated transparent acrylic emulsion packaged as a tape sealant to bulk customers.

16. The process of claim 1, wherein said acquiring comprises at least one of:
a. formulating said formulated transparent acrylic emulsion; and
b. purchasing formulated transparent acrylic emulsion.

17. A process for marketing formulated transparent acrylic emulsion as a tape sealant, the process comprising the steps of:
a. acquiring a formulated transparent acrylic emulsion by at least one of:
i. formulating said formulated transparent acrylic emulsion from transparent acrylic emulsion and at least one of:
1. a rheology modifier;
2. a dispersant;
3. a biocide;
4. a preservative; and
5. a luster-controlling agent; and
ii. purchasing said formulated transparent acrylic emulsion from a formulator; and
b. marketing said formulated transparent acrylic emulsion as a tape sealant.

18. The process of claim 17, wherein said marketing comprises the steps of:
a. packaging said formulated transparent acrylic emulsion as a tape sealant;
b. advertising said formulated transparent acrylic emulsion as a tape sealant; and
c. selling said formulated transparent acrylic emulsion as a tape sealant.

19. The process of claim 18, wherein said packaging comprises producing a retail kit comprising:
a. formulated transparent acrylic emulsion in a container, wherein said container comprises a label identifying said formulated transparent acrylic emulsion as a tape sealant;
b. instructions for using said formulated transparent acrylic emulsion as a tape sealant;
c. and at least one of:
i. an applicator for applying said formulated transparent acrylic emulsion as a tape sealant;
ii. a tape tool; and
iii. masking tape.

20. A process for marketing formulated transparent acrylic emulsion as a tape sealant, the process comprising the steps of:
a. acquiring a formulated transparent acrylic emulsion by at least one of:
i. formulating said formulated transparent acrylic emulsion from transparent acrylic emulsion and at least one of:
1. a rheology modifier;
2. a dispersant;
3. a biocide;
4. a preservative; and
5. a luster-controlling agent; and
ii. purchasing said formulated transparent acrylic emulsion from a formulator; and
b. packaging said formulated transparent acrylic emulsion as a tape sealant, said packaging further comprising at least one of:
i. producing a retail kit comprising:
1. formulated transparent acrylic emulsion in a container, wherein said container comprises a label identifying said formulated transparent acrylic emulsion as a tape sealant;
2. instructions for using said formulated transparent acrylic emulsion as a tape sealant; and at least one of:
a. an applicator for applying said formulated transparent acrylic emulsion as a tape sealant;
b. a tape tool; and
c. masking tape;
ii. producing a retail product comprising said formulated transparent acrylic emulsion in a retail container, wherein said container comprises a label identifying said formulated transparent acrylic emulsion as a tape sealant;
iii. producing a wholesale product comprising a plurality of said retail products bundled in wholesale quantities; and
iv. producing a bulk product comprising said formulated transparent acrylic emulsion in a shipping container;
c. advertising said formulated transparent acrylic emulsion as a tape sealant,wherein said advertising comprises at least one of:
i. internet advertising of said formulated transparent acrylic emulsion as a tape sealant;
ii. trade show advertising of said formulated transparent acrylic emulsion as a tape sealant;
iii. retail advertising of said formulated transparent acrylic emulsion as a tape sealant; and
iv. trade publication advertising of said formulated transparent acrylic emulsion as a tape sealant; and
d. selling said formulated transparent acrylic emulsion as a tape sealant, wherein said selling comprises at least one of:
i. selling formulated transparent acrylic emulsion packaged as a tape sealant to retail customers at least one of:
1. over the internet;
2. at a trade show; and
3. in a retail store;
ii. selling formulated transparent acrylic emulsion packaged as a tape sealant to wholesale customers at least one of:
1. on an internet wholesale sales web page;
2. using mail-order; and
3. using purchase orders; and
iii. selling formulated transparent acrylic emulsion as a tape sealant to bulk customers.
